(19) United States
(12) Patent Application Publication
(10) Pub. No.: US 2017/0018350 A1
(43) Pub. Date: Jan. 19, 2017

(54) SUPPRESSOR CHOKE

(71) Applicant: Rosenberger Hochfrequenztechnik GmbH & Co. KG, Fridolfing (DE)

(72) Inventor: Willem Blakborn, Inzell (DE)

(21) Appl. No.: 15/300,829

(22) PCT Filed: Mar. 31, 2015
(86) PCT No.: PCT/EP2015/000695

§ 371 Date: Sep. 30, 2016

(30) Foreign Application Priority Data
Apr. 8, 2014 (DE) 10 2014 005 118.8

(51) Int. Cl. H01F 27/28; H01F 41/08; H01F 41/12; H01F 27/24

(52) U.S. Cl. CPC H01F 27/2895; H01F 27/24; H01F 27/2828; H01F 41/08; H01F 41/125

(57) ABSTRACT

A suppressor choke for damping common-mode interference currents, having a core and at least two windings which each pass a number of times about the core, at least one turn of one of the windings having two rigid components which each form a turn portion and are connected to each other to form the turn.

### BACKGROUND OF THE INVENTION

1. Field of the Invention

The invention relates to a choke, in particular a suppressor choke for damping common-mode interference currents. The choke comprises a core and at least two windings which each pass a number of times around the core.

2. Description of Related Art

Chokes are typically used as suppressor chokes or suppressor filters in high current systems. A common-mode choke has several windings through which current flows in contrary directions, so that their magnetic fields cancel each other out in the core of the choke. Interference currents which also occur in the forward and return directions can be suppressed through the use of suppressor chokes. DC currents or low-frequency currents are hardly influenced by the choke. Such chokes can for example be built into inputs and outputs of power supply units in order to damp interference emissions.

Suppressor chokes generally have a closed ferrite core, in the form of a ring or another closed geometry, around which at least two windings are wound. Each winding consists of several turns which are wound around the core. The windings consist in each case of metal winding wires such as copper wires. Particularly in the case of closed cores, the winding of the cores in order to manufacture the choke is time-consuming and laborious. Moreover, in conventional suppressor chokes, the interference-suppressing effect is often not optimal.

### SUMMARY OF THE INVENTION

In view of these problems it is the object of the present invention to provide a choke which is simple to manufacture and by means of which interference currents can be effectively suppressed.

This problem is solved through a choke with the features according to the independent claims. Advantageous further developments of the choke according to the invention are described in the dependent claims.

The above and other objects, which will be apparent to those skilled in the art, are achieved in the present invention which is directed to a suppressor choke for damping common-mode interference currents, comprising a core and at least two windings which each pass a number of times around the core, such that at least one turn of one of the windings has two rigid components which each form a turn segment and which are connected with one another in order to form the turn. The core may consist of a ferromagnetic material and/or a ferrite material. The core is preferably closed, annular, and substantially toroidal in form.

The two rigid components in each case pass around the core by about 180° in the form of an arc.

Two, three, or more turns of the two windings may comprise two components connected with one another, whereby in each case two components together form a turn.

The components may be identically formed. The components are connected with one another in a form-locking, force-locking, and/or adhesively bonded manner. The components are in each case substantially C- or U-formed brackets.

The brackets include a cross-sectional area of more than 10 mm², or more than 20 mm² and less than 100 mm², so that the windings are designed for an amperage of more than 100 A, or 150 A, or more.

The components in each case have a plugging end with a plugging projection and a receiving end with a receiving recess complementary in form to the plugging projection.

The plugging projections may be in each case pressably attached into the receiving recesses of the component which continues the turn.

The components in each case preferably lie in a component plane, whereby the component planes of the components enclose a predetermined angle (a) with the component planes of the adjacent components which continue the turn, the angle preferably being more than 10° and less than 80°, in particular more than 20° and less than 60°.

In a second aspect, an embodiment of the second invention is projected to a method for manufacturing a choke, including: arranging arc-formed lower components in bracket holding sections of a first holder; arranging of arc-formed upper components in bracket holding sections of a second holder; arranging of a core between the first holder and the second holder; bringing the first holder together with the second holder, whereby the lower components and the upper components are connected with one another, so that at least two windings, each passing several times round the core, are formed.

During the bringing-together step, exposed ends of the lower components may be pressed onto exposed ends of the upper components. Furthermore, during the bringing-together step, plugging projections of the components may be pressed into receiving recesses in the components in each case continuing the winding. In addition, the suppressor choke may be sprayed with a plastic material and then installed in an electrical unit such as a power supply unit or a battery unit.

### BRIEF DESCRIPTION OF THE DRAWINGS

The features of the invention believed to be novel and the elements characteristic of the invention are set forth with particularity in the appended claims. The FIGS. are for illustration purposes only and are not drawn to scale. The invention itself, however, both as to organization and method of operation, may best be understood by reference to the detailed description which follows taken in conjunction with the accompanying drawings in which:

FIG. 1 shows a diagrammatic sketch of a suppressor choke according to the invention in a top view;

FIG. 2 shows a diagrammatic sketch of a suppressor choke according to the invention in a perspective view; and

FIG. 3 shows sectional view of a component for the manufacture of a winding of a suppressor choke according to the invention.

### DESCRIPTION OF THE PREFERRED EMBODIMENT(s)

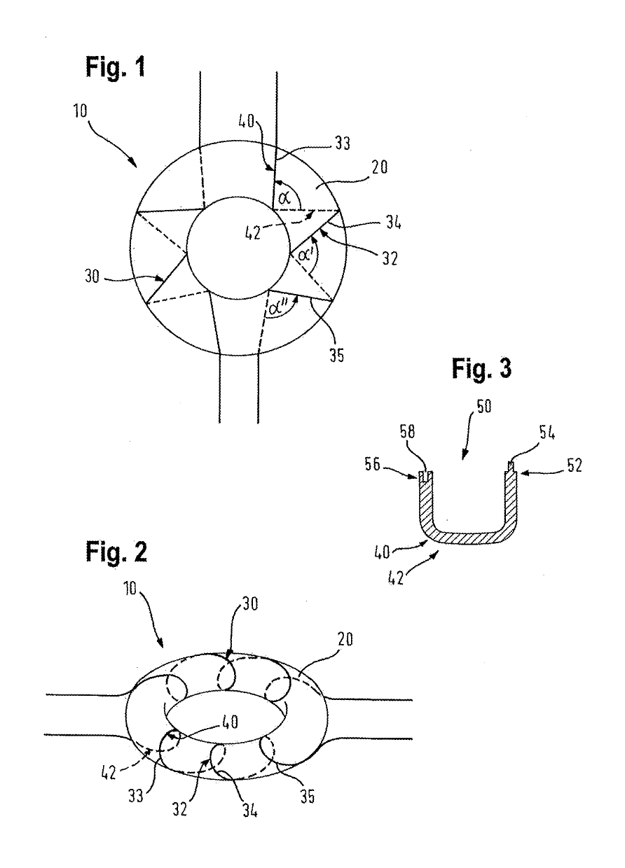

In describing the preferred embodiment of the present invention, reference will be made herein to FIGS. 1-3 of the drawings in which like numerals refer to like features of the invention.

In the choke according to the invention, at least one turn of one of the windings has two preferably rigid components which each form a turn segment and which are connected with one another in order to form the turn. In other words, the windings are not wound from a continuous winding wire, i.e., manufactured from a single-piece conductor. Instead, the windings comprise at least two connected current-conducting components which are connected with one another in order to form one or more turns of the winding. The components are manufactured as separate components and are only connected with one another in order to form the winding.

Unlike a conventional winding wire, the connected components are not flexible, but preferably rigid in form. A “rigid” (or stable-form) component is understood to mean a component which can only be bent or deformed through the application of considerable force. For example, a copper conductor with a diameter of around 2 mm or over can no longer be deformed by hand without considerable effort and thus represents a rigid component in the sense of the present invention.

The invention is based on the knowledge that, particularly in the case of a closed circumferential choke core, winding the core with a winding wire is particularly time-consuming, since for each turn the winding wire has to be passed through the central opening of the core. The step of threading the winding wire through the core opening is also generally problematic for winding machines. In addition, suppressor chokes regularly carry high currents and are therefore adapted for high amperages. However, the large conductor cross sections required for this purpose reduce the flexibility of the winding wires which are used and make them particularly rigid, which makes the winding of the cores even more difficult. Since according to the invention at least one of the turns consists of two components which are connected with one another, according to the invention it is no longer necessary to pass these through the core opening in order to manufacture the choke, which reduces the effort required for its manufacture. Instead, the components forming the turn segments are already manufactured in their final form, so that no bending or deformation of a component is necessary during the manufacture of the winding.

It has also been found that, when winding the core with a wire, winding deviations or winding errors often occur which can affect the interference-suppressing effect of the choke. Since according to the invention rigid components are preferably used to manufacture the winding turns, a more exact reproducibility of the winding path is guaranteed compared with the use of a flexible wire, which can easily deviate from the actually intended path of the winding wire on being passed through the core opening. In contrast, an accidental deformation of the components forming the turn segments is ruled out due to their rigidity.

The manufacture of the choke according to the invention can be further simplified if the components forming the turn segments in each case pass around the core by around 180° in the form of an arc. In this case, exactly two components form a full winding turn.

Preferably, two, three or more turns of each of the two windings have two components connected with one another. If all or virtually all turns of the two windings have two components connected with one another, a threading of a winding wire is at no point necessary during the manufacture of the choke, as a result of which the manufacturing costs are further reduced. Two turn segments can thereby in each case together form a turn. In other words, each turn passing through 360° can consist of exactly two components which each pass around the core by around 180° in the form of an arc and are connected with one another in order to form the complete turn.

In order to avoid errors during the manufacture of the winding, it has proved advantageous for the components forming the turn segments to be identical in form. In this case the windings can in each case be manufactured from a predetermined number of identical components. For example, in order to manufacture a winding with three turns, a total of six identical components can be connected with one another, each of which is in the form of turn segment passing through 180°. The fact the whole winding can be assembled from a series of identical components further reduces the manufacturing costs.

A winding which is stable in form and which permanently retains its path can be manufactured if the components forming the turn segments are connected with one another in a form-locking, force-locking and/or adhesively bonded manner.

The components preferably consist of metal, in particular copper, in order to guarantee good conductivity. They can in each case take the form of C- or U-shaped brackets. Bracket-formed components can be manufactured simply from a strip of metal. The brackets can in each case be arc-formed, in particular roughly semi-circular, so that the connection of several brackets produces a helical winding. Such brackets are particularly suitable for a toroidal-formed core. Alternatively, the brackets can be U-formed with for example rounded corners, the shape of which is adapted to the core cross section. If the brackets are shaped in this way, the core can be inserted or accommodated between the free ends of the brackets. The free ends can, at least in a front section, be aligned parallel to one another, which facilitates connection with the free ends of adjacent brackets.

In order to adapt the choke to high amperages, the brackets preferably have a cross-sectional area of more than 10 mm², in particular more than 20 mm² and preferably less than 200 mm², in particular less than 100 mm². Conductors with such a cross-sectional area are designed for an amperage of more than 100 A, in particular 150 A or more. Also, brackets with large bracket diameters are particularly rigid, which allows deviations from the intended winding path to be reliably prevented. Unlike conventional chokes, for the reasons explained above such large conductor cross sections are not a hindrance in the manufacture of the windings of the choke according to the invention.

A simple and rapid manufacture of the winding is made possible in that the brackets in each case have a first free end with a plugging projection designed as a plugging end and a second free end with a receiving recess, complementary in form to the plugging projection, designed as a receiving end. A form- and/or force-locking connection between adjacent brackets can be achieved by plugging the plugging projection into the receiving recess of the adjacent bracket. This allows a winding which is stable in form to be manufactured. This also guarantees an electrical contact over a large area which is necessary for high amperages.

In a particularly preferred embodiment of the invention, the plugging ends of the brackets are in each case pressed into the receiving recesses of the bracket which continues the turn. A pressing process is particularly time-saving, in particular if all brackets of which the two windings are composed are pressed at the same time, so that a single pressing step is sufficient for the manufacture of the windings. Two components which are pressed into one another engage with one another in a particularly stable and permanent manner. Deviations from the intended winding path are thus ruled out if the brackets which are to be pressed together are aligned correctly with one another prior to the pressing process.

Each component forming a turn segment is preferably flat and extends in a component plane, whereby the component planes of the individual components enclose a predetermined angle with the component planes of the adjacent components which continue the turn. The winding path of the windings can thus be substantially zig-zag-formed when viewed from above.

This design leads to a high reproducibility of the winding path, since the individual components can be correctly arranged in a simple manner prior to being connected. Also, the two windings of the choke can reliably be formed so as to run contrary to one another.

Preferably, the component planes of two components which are connected with one another enclose an angle of more than 10° and less than 80°, in particular more than 20° and less than 60°. In the case of a core of non-linear design, for example a toroidal core, the angle can vary. Also, the angle can be adapted to the cross-sectional area of the components forming the turn segments. Preferably, the angles of the first winding correspond to the angles of the second winding.

A good interference-suppressing effect can be achieved if the core consists of a ferromagnetic material, in particular of a ferrite material.

A closed core is advantageous, particularly if the choke is used as a suppressor choke. Preferably, the core is annular in form and is particularly preferably toroidal in form. Other core forms such as a D-form, E-form, frame form, etc., are conceivable.

In order to achieve a particularly good interference-suppressing effect it is important that the two windings pass round the core in contrary directions. They can each have two or more, in particular three, four or five turns.

According to a further aspect, the invention relates to a method for manufacturing a choke according to the invention, in particular a suppressor choke, comprising the following method steps: arrangement of arc-formed lower components in bracket holding sections of a first holder, arrangement of arc-formed upper components in bracket holding sections of a second holder, optional arrangement of a core between the first holder and the second holder and bringing the first holder together with the second holder, whereby the lower components and the upper components are connected with one another, so that two windings, each preferably passing several times round the core, are formed from the turn segments.

Each arc-formed component preferably has two free ends. During the connection step, the first free end of an upper component is connected with the second free end of the lower component continuing the turn in an axial direction, and the second free end of the upper component is connected with the first free end of the lower component continuing the turn contrary to the axial direction. Correspondingly, the first free end of a lower component is connected with the second free end of the upper component continuing the turn in an axial direction and the second free end of the lower component is connected with the first free end of the component continuing the turn contrary to the axial direction. The first and last component of each winding, in an axial direction, is only connected with a further component at the two free ends. In this way, the lined-up components form a helical coil which passes around the core.

Otherwise than in the manufacture of conventional windings, in which the conductor which is to be wound has to be passed through a central opening of the core, in order to manufacture the choke according to the invention the step of bringing the lower components together with the upper components is sufficient.

Preferably, the exposed ends of the lower components are pressed onto the exposed ends of the upper components during the bringing-together step. This creates a force-locking pressed connection which is particularly durable and guarantees a winding which is stable in form.

In order to achieve a stable connection between the components it has proved practical, during the bringing-together step, for the plugging projections on the first free ends of the components to be pressed into the corresponding receiving recesses on the second free ends of the components continuing the turn.

In order to manufacture a compact choke which is flexible in use, the core together with the windings is sprayed with a plastic material and then preferably installed in an electrical unit such as a power supply unit or a battery unit.

A suppressor choke according to the invention 10 is shown in a top view in FIG. 1. The suppressor choke 10 has a substantially toroidal core 20, for example a ferrite core or iron core, around which two windings 30, 32 are wound in contrary directions. Alternatively, the choke according to the invention can also have only one winding or more than two windings. Each of the windings 30, 32 consists of three complete turns 33, 34, 35. Alternatively, the windings 30, 32 can also have more or less than three turns, for example two, four or five turns. A winding does not necessarily have a whole number of turns.

The two windings 30, 32 are wound, in contrary directions, on opposite sides of the core 20 in such a way that in particular high frequency interference radiation and other interference influences in the two windings can be effectively suppressed.

The individual turns 33, 34, 35 in each case consist of two identically formed components 40, 42 in the form of brackets 50 which each surround the core by around 180°, so that two connected components form a complete 360° turn. Alternatively, at least one component surrounds the core by less or more than 180°. For example, a turn consists of more than two connected components, for example four components which in each case pass around 90°. Alternatively, not all components are identically formed. For example, the components arranged on one side of the core (lower components 42) have, at least in sections, a different form to the components arranged on the other side of the core (upper components 40). Alternatively, or additionally, if necessary the first or last component of a winding can be different in form to the other components. In the choke illustrated in FIGS. 1 and 2, each winding 30, 32 has three turns and thus six components 40, 42. In total, the two windings 30, 32 consist of twelve identically formed components, one of which is shown in cross section in FIG. 3.

The components 42, 44 are in each case stable in form or rigid. They can consist of a rod-formed metal conductor such as a copper conductor which is bent into a C- or U-form. The cross-sectional area of the components is around 25 mm², whereby smaller or larger cross-sectional areas can be used according to requirements. Amperages of between 100 A and 150 A can flow through a copper conductor with a cross-sectional area of around 25 mm² without the conductor becoming overheated or damaged.

Since the components 40, 42 are designed to be stable in form, their accidental deformation or bending during the winding of the core can be avoided. The connection points between the individual components are also preferably so stable that after the connection has been created no mutual relative movement of the connected components is possible. The winding of a choke according to the invention then permanently follows the intended path and is particularly stable in form.

As shown in FIG. 3, the components 40, 42 are substantially U-formed in the illustrated exemplary embodiment of the invention. They have two free ends which are designed for connection with the identically formed components 40, 42 which continue the turn. The core 20 passes through between the two free ends. The connection plane in which the components are in each case connected with the components which continue the winding corresponds to the radial plane running through the center of the core opening.

On the first free end (plugging end 52), each component 40 has a plugging projection 54 which can project in the form of a pin from the first front surface of the component 40. On the second free end (receiving end 56), each component 40 has a receiving recess 58 formed in the second front surface of the component 40 which is designed to be complementary to the pin-formed plugging projection 54, and into which the plugging projection 56 of an identically formed second component 42, which continues the winding, can be pressed. In this way, a force-locking connection of the components 40, 42 in order to form a turn is possible.

The U-formed curved components each lie in a component plane. The component planes of the components forming the windings can be recognized particularly clearly in FIG. 1. The components which are to be connected together are in each case aligned prior to pressing in such a way that the component planes of adjacent components in each case enclose a predetermined angle α, α′, α″, which is preferably greater than 20° and less than 60°. This leads to the zig-zag line which can be seen in FIG. 1, which is formed by the lined-up upper and lower half-turns. The angles α, α′ and α″ are not necessarily the same, particularly in the case of a ring-formed core. Preferably, the angles between the component planes of opposing components of the first winding 30 and the second winding 32 correspond. The predetermined sequence of angles α, α′, α″ is defined depending on the form of the core, the conductor cross section and the number of turns per winding such that a preferably regular winding is formed which is particularly well and permanently adapted to the core, without it being possible for the individual turns to contact one another. The advantage of a fixed predetermined sequence of angles α, α′, α″ is the exact reproducibility of the windings in order to achieve a particularly good interference damping by the suppressor choke.

The choke according to the invention 10 can be manufactured as follows: First, arc-formed lower components are arranged in bracket holding sections of a first holder and arc-formed upper components are arranged in bracket holding sections of a second holder. By means of the bracket holding sections, the components forming the turn segments 40, 42 are in each case held in a predetermined relative position and relative angular orientation in which the components 40, 42 are also to be arranged relative to one another after formation of the windings 30, 32. The holder can be part of an assembly tool which for example has holding plates with recesses designed to hold the components. The free ends of the lower components 42 (plugging end 52 and receiving end 56) are thereby exposed, so that they can be pressed onto the free ends, also exposed, of the upper components 40. The core 20 is arranged between the first holder and the second holder. The first holder and the second holder are then brought together, whereby the lower components 42 and the upper components 40 are connected with one another through pressing, so that two windings 30, 32 which each pass a number of times around the core 20 are formed from the turn segments.

During the bringing-together step, the plugging projections of the components are in each case inserted into the receiving recesses of the next components, so that a force-locking connection of the components is created. The suppressor choke can then be sprayed with a plastic material and if necessary built into an electrical unit such as a high voltage (HV) battery.

On the one hand, spraying with a (non-conductive) plastic material allows the winding path to be permanently mechanically fixed. On the other hand this ensures that the individual turns do not contact one another and are electrically insulated from one another.

### LIST OF REFERENCE NUMBERS

10 choke
20 core
30 first winding
32 second winding
33, 34, 35 turns of the second winding
40, 42 components
50 brackets
52 plugging end (first free end)
54 plugging projection
56 receiving end (second free end)
58 receiving recess

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A suppressor choke for damping common-mode interference currents, comprising a core and at least two windings which each pass a number of times around the core, such that at least one turn of one of the windings has two rigid components which each form a turn segment and which are connected with one another in order to form the turn.

2. The suppressor choke of claim 1, wherein the two rigid components in each case pass around the core by about 180° in the form of an arc.

3. The suppressor choke of claim 1, wherein two, three, or more turns of the two windings comprise two components connected with one another, whereby in each case two components together form a turn.

4. The suppressor choke of claim 1, wherein the components are identically formed.

5. The suppressor choke of claim 1, wherein the components are connected with one another in a form-locking, force-locking, and/or adhesively bonded manner.

6. The suppressor choke of claim 1, wherein the components are in each case substantially C- or U-formed brackets.

7. The suppressor choke of claim 6, wherein the brackets include a cross-sectional area of more than 10 mm², more than 20 mm² and less than 100 mm², so that the windings are designed for an amperage of more than 100 A, or 150 A, or more.

8. The suppressor choke of claim 1, wherein the components in each case have a plugging end with a plugging projection and a receiving end with a receiving recess complementary in form to the plugging projection.

9. The suppressor choke of claim 8, wherein the plugging projections are in each case pressably attached into the receiving recesses of the component which continues the turn.

10. The suppressor choke of claim 1, wherein the components in each case lie in a component plane, whereby the component planes of the components enclose a predetermined angle (α) with the component planes of the adjacent components which continue the turn, said angle preferably being more than 10° and less than 80°, in particular more than 20° and less than 60°.

11. The suppressor choke of claim 1, wherein the core consists of a ferromagnetic material and/or a ferrite material.

12. The suppressor choke of claim 1, wherein the core is closed, annular, and substantially toroidal in form.

13. The suppressor choke of claim 1, wherein the two windings pass round the core in contrary directions and each have two or more turns.

14. A method for manufacturing a choke, including:
arranging arc-formed lower components in bracket holding sections of a first holder;
arranging of arc-formed upper components in bracket holding sections of a second holder;
arranging of a core between the first holder and the second holder;
bringing the first holder together with the second holder, whereby the lower components and the upper components are connected with one another, so that at least two windings, each passing several times round the core, are formed.

15. The method of claim 14, wherein during the bringing-together step, exposed ends of the lower components are pressed onto exposed ends of the upper components.

16. The method of claim 14, wherein, during the bringing-together step, plugging projections of the components are pressed into receiving recesses in the components in each case continuing the winding.

17. The method of claim 14, wherein the suppressor choke is sprayed with a plastic material and then installed in an electrical unit such as a power supply unit or a battery unit.

18. The suppressor choke of claim 6, wherein the C- or U-formed brackets are metal brackets.

19. The suppressor choke of claim 18, wherein the C- or U-formed brackets are copper brackets.

20. The suppressor choke of claim 3, wherein the components in each case have a plugging end with a plugging projection and a receiving end with a receiving recess complementary in form to the plugging projection.

21. The suppressor choke of claim 3, wherein the components in each case lie in a component plane, whereby the component planes of the components enclose a predetermined angle (α) with the component planes of the adjacent components which continue the turn, said angle preferably being more than 10° and less than 80°, in particular more than 20° and less than 60°.
